(19) United States
(12) Patent Application Publication
(10) Pub. No.: US 2003/0156127 A1
(43) Pub. Date: Aug. 21, 2003

(54) METHOD AND SYSTEM FOR VERIFYING THE INTEGRITY OF A CAD FORMAT TRANSLATION

(76) Inventor: VADIM KLEYMAN, ANDOVER, MA (US)

Correspondence Address: LAHIVE & COCKFIELD, 28 STATE STREET, BOSTON, MA, 02109, US

(21) Appl. No.: 09/317,765

(22) Filed: May 24, 1999

(51) Int. Cl. G09G 5/00

(52) U.S. Cl. 345/672

(57) ABSTRACT

A method for determining the existence of an error in translating from a source format of a geometric object to the corresponding target format and correcting that error includes the step of specifying constraints to be satisfied by the constituents of the geometric object and augmenting the target format representation of the object with those constraints. The resulting target representation thus includes both geometric and constraint information. The validity of the translation is assessed by determining whether or not the geometric portion is consistent with the constraint portion. If it is not consistent, the constraint information is then used to correct the translation errors. The constraints are either specified by a user, known beforehand, or heuristically determined.

This application relates to computer-aided-design systems, and in particular, to methods for detecting and correcting errors arising from such causes as translation of CAD data from one CAD format to another.

### BACKGROUND

A computer-aided design (CAD) system is a tool for creating models of geometric objects on a computer system. These geometric objects, which are typically representative of physical structures, are built by a user using a series of commands that instruct the system to produce primitive entities such as solids, curves, or lines, to define their dimensions, to translate or rotate them through space, and to combine them in a variety of ways.

A geometric object created by a CAD system is typically represented using a proprietary format that depends on the particular CAD system creating the object. Because the format for an object created by one CAD system is generally different from the format for an object created by another CAD system, it is not possible for one CAD system to operate directly on an object created by another CAD system.

This inability to freely operate on objects created by a variety of CAD systems is disadvantageous in an environment in which each of several users contributes a particular component or sub-assembly of a larger structure. In such environments, which are increasingly common for the preparation of models of complex systems, different components are created with different CAD systems and integrated into a single heterogeneous assembly of components.

It is known in the art to provide translation mechanisms to transform a data structure representative of a geometric object in a source format into a corresponding data structure in a target format. It is also known to represent geometric objects in a common format (for example, the IGES format) which is understood by a variety of CAD systems.

A difficulty that arises, however, is that the translation from a structure represented in a source format into a corresponding structure represented in a target format may not be perfect. As a result, the structure as represented in the target format and the structure as represented in the source format may differ in significant ways. These imperfections can arise from a variety of causes. For example, since a digital computer generally supports only a finite number of significant digits, it is possible that, as a geometric object undergoes translations and rotations, truncation and round-off errors will accumulate. In addition, certain complex geometric entities, such a spline curves, are represented by equations which are themselves approximations of the actual entity. This can result in errors which, although small in the source format, become enlarged during the translation process. Yet another source of imperfection in translation arises from the fact that the tolerances in the source CAD system can be different from the tolerances in the target CAD system. For example, two surfaces considered to be contiguous in the source CAD system may be separated by a gap in a target CAD system.

These imperfections in the translation from the source format to the target format manifest themselves in a variety of ways. For example, FIG. 1 shows how two surfaces 42a, 44a that are contiguous in the source format can emerge, after translation into the target format, as two surfaces 42b, 44b slightly displaced relative to each other so that the surfaces are no longer contiguous. FIG. 1 also shows how two vertices 40a, 43a sharing the same spatial location in the source format can emerge, after translation into the target format, as two vertices 40b, 43b that are slightly displaced relative to each other. In some cases, surfaces that are tangent along their common boundary when represented in the source format are no longer tangent in the target format representation of those two surfaces.

It is difficult, using conventional surface models of structures, to detect, much less correct, such errors in translation. This is because the target application has no way of knowing that a representation of the structure in the target format is not, in fact, a perfectly accurate representation of the structure as represented in the source format. In effect, because the target application has no context against which to evaluate the integrity of a translation, it has no choice but to accept the translation on faith. As a result of the target applications blind reliance on the integrity of the translation process, it is frequently necessary for designers who import geometric objects from other CAD systems to spend considerable amounts of time making minor changes to the imported structure in order to perfect the translation. The effort associated with this correction process significantly inhibits the free exchange of geometric structures between different CAD systems having different formats for representing geometric objects.

What is therefore lacking in the art is a method for detecting and correcting such translation errors, thereby facilitating the free exchange of geometric structures created in a variety of CAD systems.

A related difficulty arises outside the context of translation between a source format and a target format. For example, there are a variety of ways known to generate a surface by applying procedures to other geometric structures. For example, one can generate a surface by interpolating over a set of points in three-dimensional space. Or, one can generate a surface by defining two curves in three-dimensional space and connecting points on one curve with corresponding points on the other curve. However, two surfaces generated in this manner are not guaranteed to be contiguous or to satisfy any other constraint relative to each other. As a result, the two surfaces are quite simple, a designer who creates two such surfaces and seeks to join them together faces a potentially non-trivial task.

What is therefore also lacking in the art is a method for creating and enforcing constraints between two surfaces.

### SUMMARY

In a method of practicing the invention, an independent basis for verifying the integrity of a translation from a source format representation of a geometric structure to a target format representation of the same structure includes the step of enhancing the target format representation by incorporating into it certain constraints on the constituent elements of the structure that are expected to be satisfied in the source format representation of the geometric structure. The geometric structure generally has a first element, a second element, and a common boundary between the first and second element and the constraint is to be satisfied by the first element at the common boundary.

To verify the integrity of the translation, the method of practicing the invention includes the step of determining whether or not the constraint is satisfied by the first element in the target format representation of the geometric structure and verifying the integrity of the translation process on the basis of whether the constraint is satisfied by the first element in the target format representation of the geometric structure. This generally includes the step of examining the common boundary between the first and second elements of the geometric structure in the target format to determine if the constraint is satisfied at that boundary.

Having detected the existence of an error in translation in the foregoing manner, the method of the invention can include the additional step of correcting the translation error by enforcing the constraint at the common boundary between the first and second constituent elements in the target format representation of the geometric structure. This can include the step of altering the target format representation of the structure so as to satisfy the constraints. The step of altering the target format representation to satisfy the constraint at the common boundary can be implemented by perturbing only the first element and constraining the second element to be stationary or by perturbing both the first and second elements.

The constraints can be generated either interactively, with the user of the data processing system specifying the constraints from an input device, or automatically. The step of automatically generating constraints typically includes the step of applying pre-defined assumptions concerning the geometric structure. These pre-defined assumptions can reflect either prior knowledge of the structure or heuristically derived rules for representation of the structure. Examples of such heuristically defined rules are that elements whose boundaries are separated by a distance small compared to the overall dimension of the structure are expected to be contiguous at those boundaries and that curved elements that share a common boundary are expected to be tangent to each other at the boundary.

The foregoing method can be used in applications other than the correction of errors associated with translation from a source format to a target format. The method is sufficiently general in its scope to be used to enforce constraints between two constituents of a geometric structure regardless of the origin of the geometric structure. In particular, a user of a CAD system can apply the foregoing method to enforce a constraint between two constituent elements of a geometric object created using that CAD system. This application of the foregoing method can be considered a limiting case in which the source format and the target format are the same format.

These and other features, aspects, and advantages of the invention will be better understood with reference to the following description and the accompanying drawings in which:

### BRIEF DESCRIPTION OF THE DRAWINGS

FIG. 1 illustrates how, as a result of a translation error, the target format representation of a geometric object can differ from the source format representation of the geometric object;

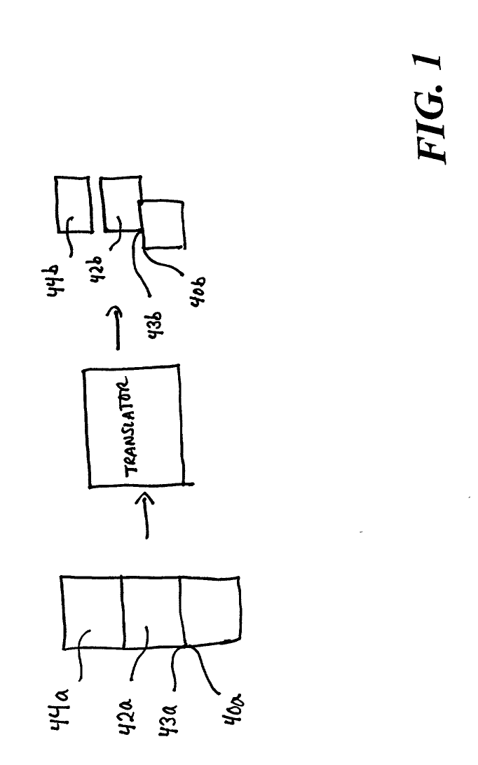

FIG. 2 shows a block diagram of a plurality of CAD systems in communication with a geometry database in a system embodying the principles of the invention;

FIG. 3 is a schematic depiction of the geometry editor in one of the CAD systems shown in FIG. 2;

FIG. 4 is a flowchart of the steps implemented by the geometry editor of FIG. 3; and

FIG. 5A shows a section of a translated object as output by the translator array of FIG. 3 in which components of the structure are displaced as a result of translation errors; and

FIG. 5B shows the translated object of FIG. 5A after repairs made by the constraint enforcer of FIG. 3.

### DETAILED DESCRIPTION

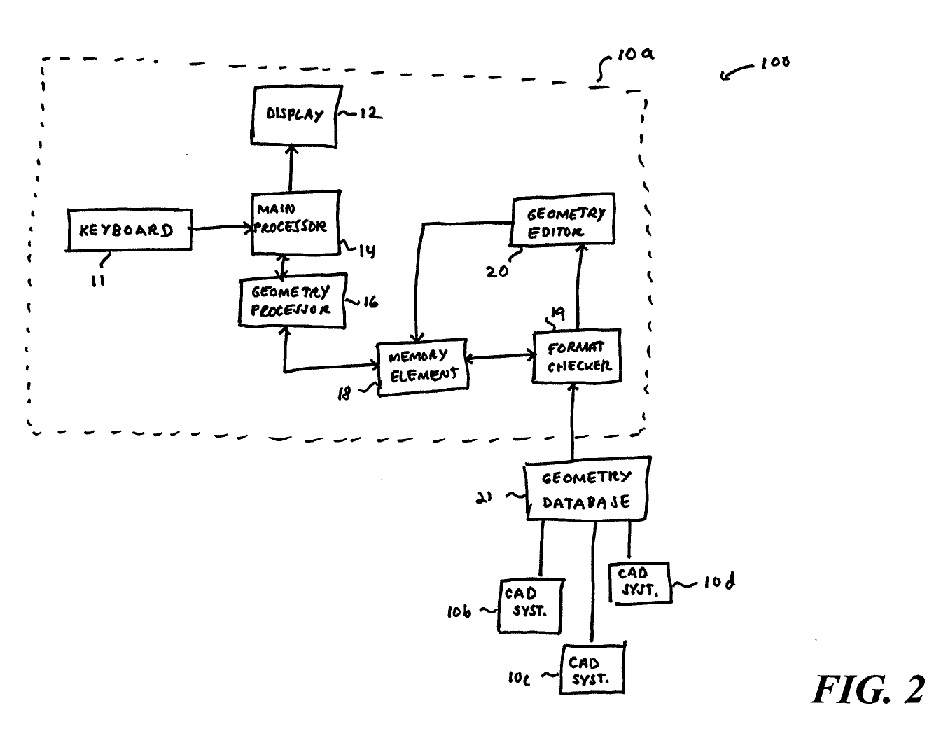

Referring to FIG. 2, a data processing system 100 embodying the invention includes a first CAD system 10a linked to a geometry database 21 of geometric objects. The first CAD system can be a CAD system such as PROENGINEER 2000, available from Parametric Technology of Waltham, Mass.

The geometry database 21 can be a collection of files on a server or distributed across several servers. Alternatively, the database can be an enterprise-wide data management system such as the WINDCHILL system available from Parametric Technology of Waltham, Mass. The geometry database 21 is linked to a plurality of CAD systems, 10b-10d, all of which can store and retrieve geometric objects in the geometry database 21. Each of the plurality of CAD systems 10b-10d includes components similar to those described below in connection with the first CAD system 10a.

The first CAD system 10a includes one or more input devices 11, typically a keyboard operating in conjunction with a mouse or similar pointing device, for communicating instructions from a user to a main processor 14. The main processor 14 is coupled both to a graphics processor 16, which can be a separate hardware element or executable software loaded into memory, and to a display terminal 12.

The main processor 14 routes those instruction received from the user that are related to the creation and manipulation of geometric objects to the graphics processor 16 and receives instructions from the graphics processor 16 to display appropriate geometric structures on the display terminal 12. The resulting display on the display terminal 12 provides visual feedback to the user of the first CAD system 10a.

The graphics processor 16 is connected to a memory element 18 in which is stored a representation of a geometric object to be operated upon by the graphics processor 16. There are two ways in which this geometric object can be placed into the memory element 18. The first way is to create the object directly in the memory element 18 using CAD system commands available for this purpose. The second way is to retrieve the geometric object from the geometry database 21 and place it into the memory element 18.

If the geometric object is retrieved from the geometry database 21, the possibility exists that the object was stored in a format that is not readily understood by the first CAD system. It is therefore necessary to provide a format checker 19 to intercept geometric objects retrieved from the geometry database 21 before they reach the memory element 18.

The format checker 19 determines whether the geometric object 201 (hereafter referred to as the retrieved object 201) retrieved from the geometry database 21 is of a type that can be understood by the graphics processor 16. If it is, then no translation is necessary and the retrieved object 201 is placed directly into the memory element 18. If it is not, the retrieved object 201 must first be passed through a geometry editor 20 before it can be placed into the memory element 18.

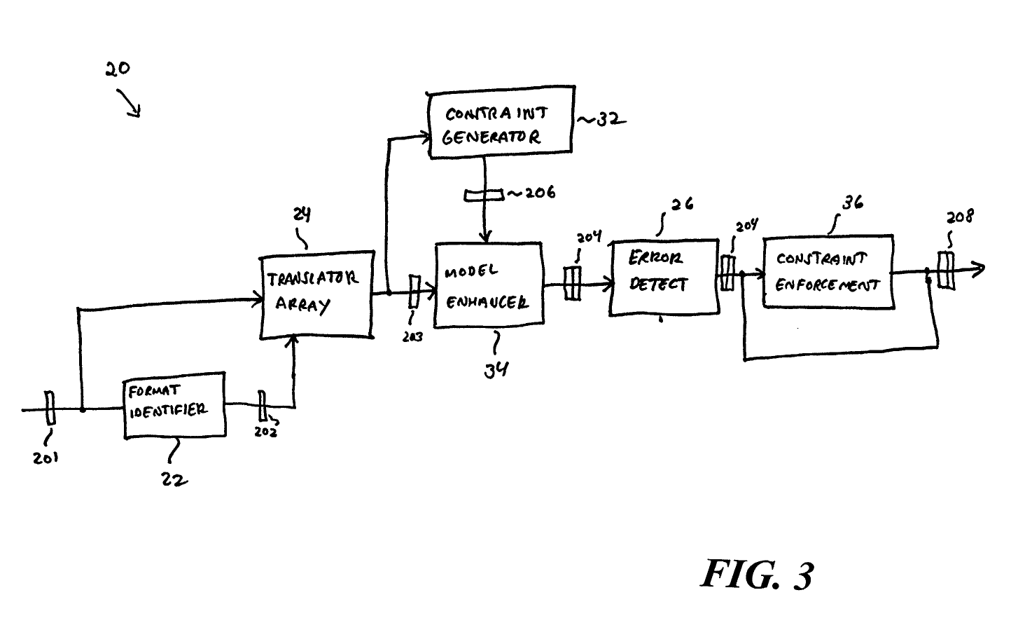

The geometry editor 20 of the first CAD system 10a, shown in more detail in FIG. 3, includes a format identifier 22 coupled to a translator array 24. The format identifier 22 examines the retrieved object 201 and determines which of several available CAD formats the retrieved object 201 is represented in. The format identifier 22 then sends a selection signal 202 encoding this information to a translator array 24. The translator array 24 then applies an appropriate translator to the retrieved object 201, thereby generating a translated object 203.

The retrieved object 201 is typically stored in a source format that contains only geometric information regarding the object. Such information includes the locations of vertices, curves and surfaces in a coordinate system, or equations defining surfaces and curves. The retrieved object 201 (and hence the translated object 203) generally does not include information regarding the desired relationships between particular vertices, curves and surfaces. Of course, if the geometric information is specified exactly and translated with no errors, any desired relationships between the various vertices, curves and surfaces in the translated object 203 will be satisfied. However, the fact that the desired relationships are satisfied is merely a byproduct of having correctly specified the locations of all vertices, curves and surfaces in the retrieved object 201.

As an example, consider a model of a boat in which one surface represents the keel and another surface represents the hull. The source format representation of the retrieved object 201 may include an equation for a surface defining the keel and another equation for the surface defining the hull. If these two equations are both chosen correctly, the keel and the hull will intersect and be orthogonal to each other at the locus of points defining their intersection. The source format representation does not, however, include an independent statement of the fact that the keel and hull must intersect orthogonally along a line. This requirement, if satisfied, is satisfied only as a byproduct of the choice of the equations describing the hull and the keel.

Because the retrieved object 201, and hence the translated object 203 contains only geometric information regarding the structure, there is no independent basis for assessing the integrity of the translation process. Thus, in the context of the above example, if, upon translation, the model of the boat shows a keel that is almost, but not quite orthogonal to the hull, the CAD system will have no basis for determining whether there has been a translation error, or whether this slight deviation from orthogonality is the result of a deliberate choice made by a designer.

In a system embodying the invention, an independent basis for evaluating the integrity of the translation process is provided by a constraint generator 32 in communication with the translator array 24. The constraint generator 32 heuristically determines the constraints imposed on the model by the designer. For example, if the constraint generator 32 observes that, in the translated object 203, two surfaces are separated by a gap that is very small compared to the overall dimensions of the structure, the constraint generator 32 will assume that an error has been made in translation and that the two surfaces are meant to be joined. The constraint generator 32 then transmits a signal containing constraint information 206 to a model enhancer 34 that incorporates this information into the translated object 203.

The model enhancer 34 incorporates the constraint information 206 by generating a hybrid object 204 in which the translated object 203 is augmented by information about relationships that must be satisfied between the various constituents of the structure. These relationships, which are collectively referred to as constraint information 206, can either be generated heuristically by the constraint generator 32 as described above, or they can be provided directly by the user. The resulting hybrid object 204 thus contains two distinct portions: a geometry portion obtained directly from the translated object 203 output by the translator array 24 and a constraint portion obtained from the constraint generator 32 and combined with the geometry portion by the model enhancer 34.

In the preferred embodiment, the constraint information 206 take the form of constraints that are to be satisfied at the boundaries between the various constituents of the structure. Examples of such constraints are: that two surfaces are continuous at their boundary, that two surfaces are tangent at their boundary, or that two surfaces intersect at a specified angle. However, the constraints can be far more complex. For example, one can constrain the center of mass to be located at a certain point, or one can constrain the moment of inertia about a selected axis of the resulting structure be a particular value. The constraint information 206 can be applied to any n−1 manifold boundary of an n manifold object. For example, the constraint generator 32 can impose a constraint at the vertices that form the boundaries of a curve as well as a constraint at the curve forming a boundary between two surfaces.

Because the hybrid object 204 includes both a constraint portion and geometry portion, an error detector 26 can determine whether the geometry portion and the constraint portion are consistent. The error detector 26 does so by determining whether the structure generated by the geometry portion satisfies the constraints imposed by the constraint portion. The constraint portion thus provides an independent check on the validity and internal self-consistency of the translated object 203. As a result, the error detector 26 can determine whether or not an error has occurred in generating the translated object 203 from the retrieved object 201.

Without the constraint information 206 encoded in the hybrid object 204, the first CAD system 10a, when presented, for example, with two surfaces that are very close to being aligned, has no basis for determining whether or not a translation error has occurred or whether the two surfaces are, in fact, supposed to be misaligned. However, if the constraint information 206 encoded into the hybrid object 204 states that the two faces are supposed to be aligned, then the first CAD system 10a, when faced with the misaligned structures in the translated representation of the structure, has a basis for recognizing that the translation is faulty.

If it does not detect any errors in the geometric portion of the hybrid object 204, the error detector 26 routes the hybrid object 204 directly to the output of the geometry editor 20 where it is made available for loading into the memory element 18. If, on the other hand, the error detector 26 detects that one or more constraints specified in the constraint portion of the hybrid object 204 are not satisfied in the geometry portion, the hybrid object 204 is first passed to a repair module 36 before being made available to the memory element.

The constraint enforcement module 36 repairs the hybrid object 204 by adjusting the geometry portion of the hybrid object 204 so as to satisfy the constraints specified in the constraint portion of the hybrid object 204. This process typically includes perturbation of one or more constituents of the geometric object in an effort to satisfy the constraints. In some cases, the constraint may impose limitations on the amount by which a particular constituent of the geometric object may be perturbed. For example, a constraint may specify that two structures are to be contiguous but that in the event they are not contiguous, one of the two surfaces must remain stationary.

The output of the constraint enforcement module 36 is a repaired hybrid object 208 which becomes the output of the geometry editor 20. This output is then made available to the memory element 18 where it can be operated upon by the graphics processor 16 of the first CAD system 10a.

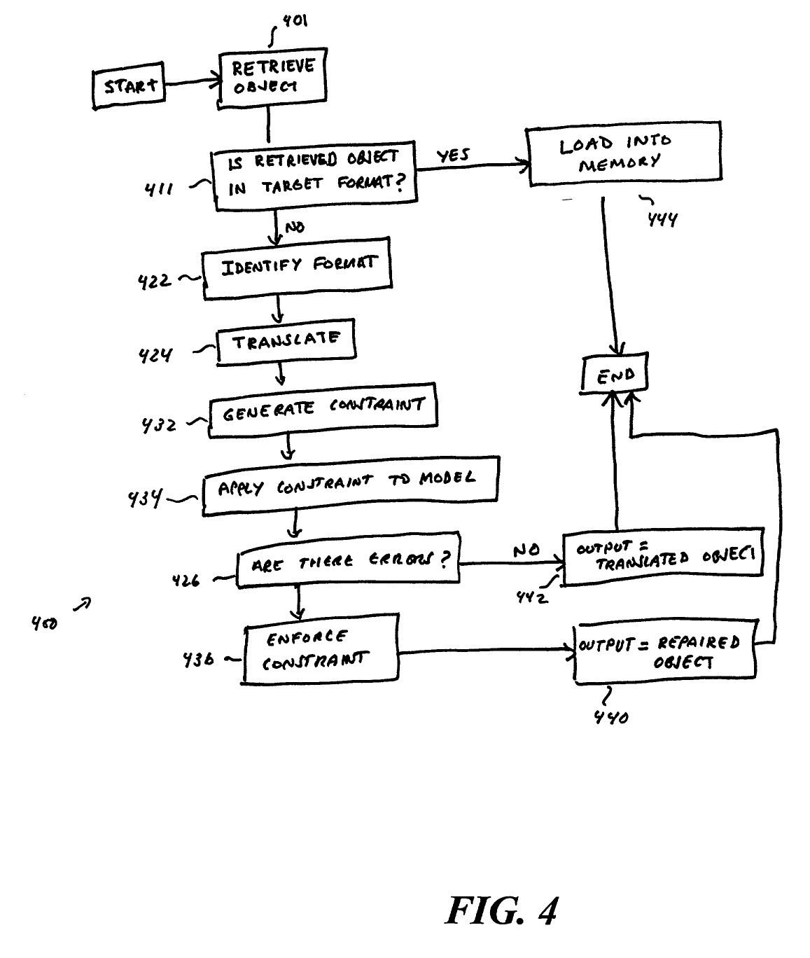

FIG. 4 shows a flowchart illustrating the steps used to verify the integrity of the translation from the source format to the target format and to repair the target format so that it is consistent with the source format. The method 400 begins with the step 401 of retrieving an object from the geometry database and determining 411 whether the retrieved object is in a format that can be understood by the CAD system. If it is, then the retrieved object is routed 444 directly to the memory element. If it is not, then the retrieved object is passed to the geometry editor.

Once the retrieved object is passed to the geometry editor, its format is identified 422 and translated from that format into a translated object format that can be understood by the CAD system. Meanwhile, any constraints associated with the structure are generated 432 and incorporated 434 into the translated object, thereby generating a hybrid object having a geometry portion and a constraint portion.

The next step in the method of the invention is to determine 426 whether there has been an error in translation. This is done by determining whether the generated constraints in the constraint portion of the hybrid object are satisfied by the geometry portion of that object. If they are, then output of the geometry editor is set 442 to be the translated model. Otherwise, the translated object is repaired by enforcing 436 the constraints generated in step 432 of the illustrated method 400. The repair, or constraint enforcement process generally includes the step of perturbing the constituents of the geometric object represented by the geometric portion of the hybrid object so as to satisfy the constraints. After undergoing repairs in this manner, the hybrid object (now referred to as the “repaired object”) is set 440 to be the output of the geometry editor.

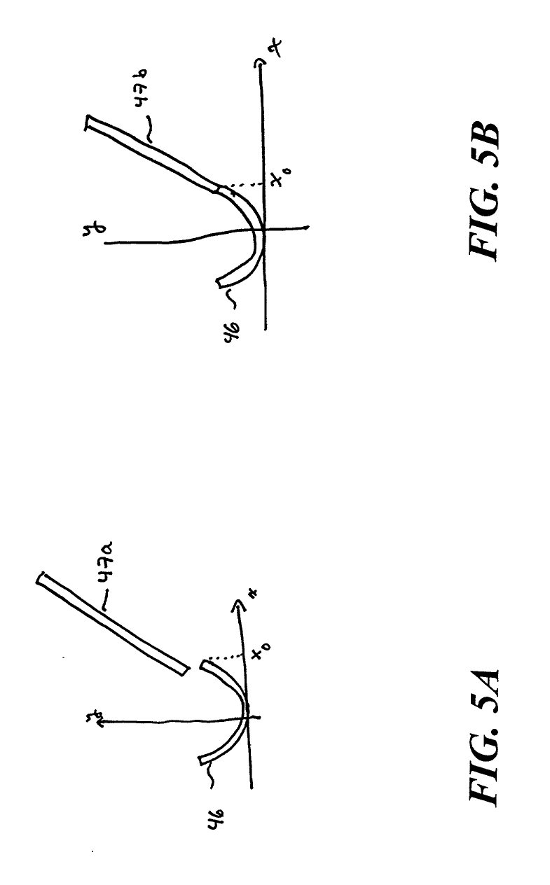

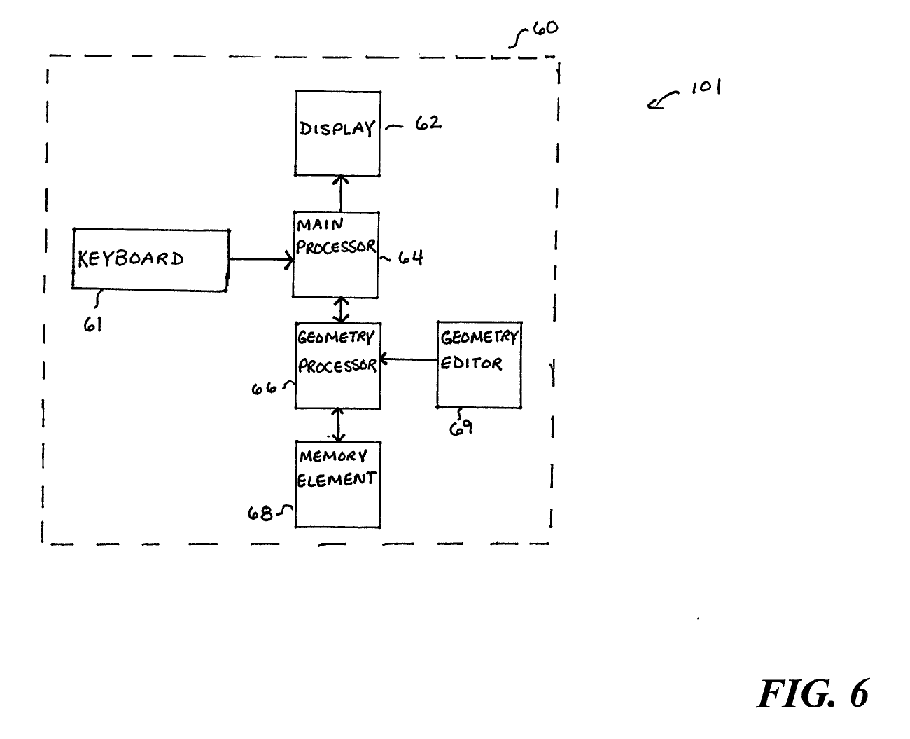

An example of the type of perturbation performed by the constraint enforcer 36 is illustrated in FIGS. 5A and 5B. FIG. 5A shows, in cross-section, a translated object 203 that includes a section of a parabolic cylinder 46 and a plane 47a. In the translated object 203, the cross-section of the parabolic cylinder 46 is defined by the equation

y=x² (1)

and the cross-section of the plane 47a is defined by the equation

y=(2.001x₀)x−1.001x₀² (2)

As a result, the plane 47a and the parabolic cylinder 46 are neither continuous nor tangential along their boundaries.

A user observing this apparent translation error can instruct the constraint generator 32 to generate three constraints to be satisfied by the parabolic cylinder 46 and the plane 47a along their boundaries: that they are contiguous, that they are tangential, and that the parabolic cylinder 46 be held stationary. These constraints can be provided interactively by the user, as described above, or they can be generated automatically by heuristic rules. Whichever way they are generated, the model enhancer 34 incorporates them into the translated object 203, thereby generating a hybrid object 204 having a geometry portion and a constraint portion.

When the hybrid object 204 is passed to the error detector 26, the error detector 26 recognizes that the constraint portion of the hybrid object 204 is inconsistent with the geometry portion of that object. In response, the error detector 26 passes the hybrid object 204 to the constraint enforcer 36 for repairs consistent with the constraint portion of the hybrid object 204.

The repaired hybrid object 208 generated by the constraint enforcer is shown in FIG. 5B. Because of the constraint that the parabolic cylinder 46 is to be held stationary, the constraint enforcer leaves equation (1) for the parabolic cylinder 46 unchanged. Because of the constraint that the two surfaces must be contiguous along their boundary, the constraint enforcer perturbs the y-intercept of equation (2) so that the plane 47a and the cylinder 46 meet along their boundary. Finally, because of the constraint that the two surfaces must be tangential to each other along their boundary, the constraint enforcer perturbs the slope of equation (2) so that it matches the first derivative of equation (1) along the line defining the intersection of the parabolic cylinder 46 and the plane 47a. The resulting representation of the plane 47b in the repaired hybrid object 208 is thus:

y=(2xₒ)x−x₀² (3)

The resulting representation of the plane 47b and the parabolic cylinder 46 satisfies all the constraints imposed by the constraint generator 32 and presumably undoes any errors associated with the translation process.

Having described the invention, and a preferred embodiment thereof, what I claim as new and secured by Letters Patent is:

1. In a data processing system, a method of verifying an integrity of a translation from a source format representation of a geometric structure to a corresponding target format representation of the geometric structure, the geometric structure having a first element, a second element, and a common boundary between the first element and the second element, the method comprising the steps of:
generating a constraint to be satisfied by the first element and the second element at the common boundary in the source format representation of the geometric structure;
incorporating the constraint into the target format representation of the geometric structure;
determining whether the constraint is satisfied by the first and second elements in the target format representation of the geometric structure; and
verifying the integrity of the translation process on the basis of whether the constraint is satisfied by the first element in the target format representation of the geometric structure.

2. The method of claim 1 further comprising the step of enforcing the constraint at the common boundary.

3. The method of claim 2 wherein the step of enforcing the constraint at the common boundary comprises the step of altering the target format representation of the geometric structure.

4. The method of claim 3 wherein the altering step comprises the step of perturbing the first element.

5. The method of claim 4 wherein the altering step further comprises the step of perturbing the second element.

6. The method of claim 1 wherein the step of generating a constraint comprises the step of providing a constraint generator for automatically generating a constraint on the basis of predefined assumptions concerning the geometric structure.

7. The method of claim 1 wherein the step of generating a constraint comprises the step of providing interactive means for permitting a user of the data processing system to specify the constraint.

8. The method of claim 1 wherein the step of generating a constraint comprises the step of applying a set of heuristically determined assumptions concerning the geometric structure.

9. The method of claim 1 wherein the source format and the target format representation are the same format.

10. A data processing system for verifying an integrity of a translation from a source format representation of a geometric structure into a corresponding target format representation of the geometric structure, the geometric structure having a first element, a second element, and a common boundary between the first element and the second element, the system comprising:
a constraint generator for specifying a constraint to be satisfied by the first and second elements at the common boundary in the source format representation of the geometric structure;
a model enhancer to incorporate the constraint into the target format representation of the geometric structure;
an error detector for determining whether the first element and the second element satisfy the constraint in the target format representation of the geometric structure.

11. The system of claim 10 further comprising a constraint enforcer for enforcing the constraint at the common boundary.

12. The system of claim 11 wherein the constraint enforcer comprises means for altering the target format representation of the geometric structure to enforce the constraint at the common boundary.

13. The system of claim 12 wherein the means for altering the target format representation of the geometric structure comprises means for perturbing the first element.

14. The system of claim 13 wherein the means for altering the target format representation of the geometric structure further comprises means for perturbing the second element.

15. The system of claim 10 wherein the constraint generator comprises interactive means for permitting a user of the data processing system to specify the constraint.

16. The system of claim 10 wherein the constraint generator comprises means for applying a set of heuristically determined assumptions concerning the geometric structure.

17. The system of claim 10 wherein the target format and the source format are the same format.

18. A computer-readable medium containing software instructions for verifying an integrity of a translation from a source format representation of a geometric structure to a corresponding target format representation of the geometric structure, the geometric structure having a first element, a second element, and a common boundary between the first element and the second element, the software instructions including instructions for executing the steps of:
generating a constraint to be satisfied by the first element and the second element at the common boundary in the source format representation of the geometric structure;
incorporating the constraint into the target format representation of the geometric structure;
determining whether the constraint is satisfied by the first and second elements in the target format representation of the geometric structure; and
verifying the integrity of the translation process on the basis of whether the constraint is satisfied by the first and second elements in the target format representation of the geometric structure.

19. The computer-readable medium of claim 18 further comprising instructions for enforcing the constraint at the common boundary.

20. The computer-readable medium of claim 19 wherein the software instructions for enforcing the constraint at the common boundary further comprise instructions for executing the step of altering the target format representation of the geometric structure.

21. The computer-readable medium of claim 21 wherein the software instructions for enforcing the constraint at the common boundary comprise instructions for executing the step of perturbing the first element.

22. The computer-readable medium of claim 20 wherein the software instructions for enforcing the constraint at the common boundary further comprise instructions for executing the step of perturbing the second element.

23. The computer-readable medium of claim 18 wherein the software instructions for generating a constraint comprise instructions for providing a constraint generator for automatically generating a constraint on the basis of pre-defined assumptions concerning the geometric structure.

24. The computer-readable medium of claim 18 wherein the software instructions for generating a constraint comprise instructions for providing interactive means for permitting a user of the data processing system to specify the constraint.

25. The computer-readable medium of claim 18 wherein the software instructions for generating a constraint comprise instructions for applying a set of heuristically determined assumptions concerning the geometric structure.

26. A hybrid target format representation of a geometric object having a first element, a second element and a common boundary between the first element and the second element, the hybrid target format representation being generated by
translating a source format representation of the geometric object into a target format representation of the geometric object;
generating a constraint to be satisfied, in the source format representation of the geometric structure, by the first element at the common boundary; and
incorporating the constraint into the target format representation of the geometric structure, thereby forming A hybrid target format representation of the geometric object.

27. The hybrid target format representation of claim 26 wherein the generation of the hybrid target format representation further comprises the steps of
determining whether the constraint is satisfied by the first element in the hybrid target format representation of the geometric structure; and
verifying the integrity of the translation process on the basis of whether the constraint is satisfied by the first element in the hybrid target format representation of the geometric structure.

28. The hybrid target format representation of claim 27 wherein the generation of the target format representation further comprises the step of enforcing the constraint at the common boundary.

29. The hybrid target format representation of claim 28 wherein the step of enforcing the constraint at the common boundary comprises the step of altering the target format representation of the geometric structure.

30. The hybrid target format representation of claim 28 wherein the step of enforcing the constraint at the common boundary comprises the step of perturbing the first element.

31. The hybrid target format representation of claim 27 wherein the step of enforcing the constraint at the common boundary further comprises the step of perturbing the second element.

32. The hybrid target format representation of claim 27 wherein the step of generating a constraint comprises the step of providing a constraint generator for automatically generating a constraint on the basis of pre-defined assumptions concerning the geometric structure.

33. The hybrid target format representation of claim 27 wherein the step of generating a constraint comprises the step of providing interactive means for permitting a user of the data processing system to specify the constraint.

34. The hybrid target format representation of claim 27 wherein the step of generating a constraint comprises the step of applying a set of heuristically determined assumptions concerning the geometric structure.

35. The hybrid target format representation of claim 26 wherein the source format and the target format are the same format.

36. A method for insuring the integrity of a translation of a source format representation of a geometric object to a target format representation of the geometric object, the geometric object having a first element and a second element, the method comprising the steps of:
assuming the existence of a relationship between the first and second elements of the geometric object in the source format representation of the geometric object;
translating the source format representation of the geometric object into a target format representation of the geometric object;
determining whether the assumed relationship exists in the target format representation of the geometric object; and
altering the target format representation of the geometric object to cause the relationship between the first and second elements to exist in the target format representation of the geometric object.
